(19) United States
(12) Patent Application Publication
(10) Pub. No.: US 2025/0088832 A1
(43) Pub. Date: Mar. 13, 2025

(54) SERVER DEVICE, INFORMATION COMMUNICATION SYSTEM, INFORMATION COMMUNICATION METHOD, AND PROGRAM

(71) Applicant: NEC Corporation, Minato- ku, Tokyo (JP)

(72) Inventors: Kazuki Ogata, Tokyo (JP); Kosei Kobayashi, Tokyo (JP); Tetsuji Kawatsu, Tokyo (JP); Yuji Sato, Tokyo (JP); Tetsuya TAKAKI, Tokyo (JP); Jun Takasawa, Tokyo (JP); Hiroaki Aminaka, Tokyo (JP); Kei Yanagisawa, Tokyo (JP)

(73) Assignee: NEC Corporation, Minato- ku, Tokyo (JP)

(21) Appl. No.: 18/727,394

(22) PCT Filed: Jan. 17, 2022
(86) PCT No.: PCT/JP2022/001282

§ 371 Date: Jul. 9, 2024

(51) Int. Cl. H04W 4/44; G06V 20/54; G08G 1/01; H04W 64/00

(52) U.S. Cl. CPC H04W 4/44; G06V 20/54; G08G 1/0112; G08G 1/012; G08G 1/0141; H04W 64/006; G06V 2201/08

(57) ABSTRACT

In order to make it possible to carry out communication while identifying a vehicle of an intended condition, a server apparatus (1) includes: a reception means (11) for receiving, from a first vehicle (31), a communication request message using wireless communication, the communication request message designating a selection condition for selecting another vehicle; a selection means (12) for selecting a second vehicle (33, 34) that satisfies the selection condition; and a transmission means (13) for transmitting the communication request message to the second vehicle (33, 34).

### TECHNICAL FIELD

The present invention relates to a server apparatus, an information communication system, an information communication method, and a program.

### BACKGROUND ART

In recent years, vehicle-to-vehicle (V2V) communication and vehicle-to-infrastructure (V2I) communication have become popular, and various kinds of data are exchanged using a vehicle-to-everything (V2X) communication technique. However, PC5 communication of LTE-V2X cannot cope with large-volume data communication such as video information. By using Uu communication such as a fifth-generation mobile communication system (5G), it is possible to carry out large-volume data communication. However, it is impossible to carry out communication unless information (e.g., connection destination information) for identifying a partner vehicle is known.

Patent Literature 1 indicates that a management apparatus transmits, to an in-vehicle apparatus of a vehicle, positional information of a section where traffic jam occurs or an in-vehicle apparatus present in a section where traffic jam occurs, and information pertaining to a network address or the like. Then, the in-vehicle apparatus of the vehicle selects, based on the positional information acquired from the management apparatus, a candidate camera as a candidate for camera video distribution.

Patent Literature 2 discloses selecting, from among a plurality of vehicles, a vehicle which is currently in the vicinity of a position where a user wishes to take an image or a vehicle whose planned travelling route overlaps with the vicinity of a position where a user wishes to take an image.

### CITATION LIST

### Patent Literature

[Patent Literature 1]
Japanese Patent Application Publication, Tokukai, No. 2021-056191
[Patent Literature 2]
Japanese Patent Application Publication, Tokukai, No. 2013-187877

### SUMMARY OF INVENTION

### Technical Problem

As described above, in order to carry out large-volume data communication using Uu communication such as 5G, information for identifying a partner vehicle (in-vehicle apparatus) is necessary. In Patent Literature 1, it is possible to transmit, to an in-vehicle apparatus of a vehicle, positional information of a section where traffic jam occurs or an in-vehicle apparatus present in a section where traffic jam occurs, and information pertaining to a network address or the like. However, there is a possibility that it is impossible to identify an in-vehicle apparatus of a vehicle of an intended condition.

In Patent Literature 2, it is possible to select, from among a plurality of vehicles, a vehicle which is currently in the vicinity of a position where a user wishes to take an image, or the like. However, similarly to Patent Literature 1, there is a possibility that it is impossible to identify an in-vehicle apparatus of a vehicle of an intended condition.

An example aspect of the present invention is accomplished in view of the above problems, and an example object thereof is to provide a technique which makes it possible to carry out communication while identifying a vehicle of an intended condition.

### Solution to Problem

A server apparatus in accordance with an example aspect of the present invention includes: a reception means for receiving, from a first vehicle, a communication request message using wireless communication, the communication request message designating a selection condition for selecting another vehicle; a selection means for selecting a second vehicle that satisfies the selection condition; and a transmission means for transmitting the communication request message to the second vehicle.

A server apparatus in accordance with an example aspect of the present invention includes: a reception means for receiving, from a first vehicle, a communication request message using wireless communication, the communication request message designating a selection condition for selecting another vehicle; a selection means for selecting a second vehicle that satisfies the selection condition; a storage means for storing pieces of positional information of respective vehicles included in a vehicle group and pieces of communication connection information of the respective vehicles in the wireless communication in association with each other; a retrieval means for retrieving a piece of positional information corresponding to a piece of positional information of the second vehicle with reference to the pieces of positional information of the respective vehicles which are stored in the storage means; and a transmission means for transmitting, to the first vehicle, a piece of communication connection information which is stored in the storage means and corresponds to the second vehicle in a case where the piece of positional information corresponding to the piece of positional information of the second vehicle is stored in the storage means.

An information communication system in accordance with an example aspect of the present invention includes: a reception means for receiving, from a first vehicle, a communication request message using wireless communication, the communication request message designating a selection condition for selecting another vehicle; a selection means for selecting a second vehicle that satisfies the selection condition; a first transmission means for transmitting the communication request message to the second vehicle; and a second transmission means for transmitting predetermined information possessed by the second vehicle to the first vehicle.

An information communication method in accordance with an example aspect of the present invention includes: receiving, from a first vehicle, a communication request message using wireless communication, the communication request message designating a selection condition for selecting another vehicle; selecting a second vehicle that satisfies the selection condition; and transmitting the communication request message to the second vehicle.

A program in accordance with an example aspect of the present invention causes a computer to carry out: a process of receiving, from a first vehicle, a communication request message using wireless communication, the communication request message designating a selection condition for selecting another vehicle; a process of selecting a second vehicle that satisfies the selection condition; and a process of transmitting the communication request message to the second vehicle.

### Advantageous Effects of Invention

According to an example aspect of the present invention, it is possible to carry out communication while identifying a vehicle of an intended condition.

### BRIEF DESCRIPTION OF DRAWINGS

FIG. 1 is a diagram illustrating, with example vehicles, a configuration of a server apparatus in accordance with a first example embodiment of the present invention.

FIG. 2 is a diagram for describing an example of a selection condition for selecting another vehicle.

FIG. 3 is a flowchart illustrating a flow of an information communication method carried out by the server apparatus in accordance with the first example embodiment of the present invention.

FIG. 4 is a block diagram illustrating a configuration of an information communication system in accordance with the first example embodiment of the present invention.

FIG. 5 is a flowchart illustrating a flow of an information communication method carried out by the information communication system in accordance with the first example embodiment of the present invention.

FIG. 6 is a diagram illustrating, with example intersection and imaging apparatus, a configuration of a server apparatus in accordance with a variation of the first example embodiment of the present invention.

FIG. 7 is a diagram illustrating, with example vehicles, a configuration of a server apparatus in accordance with a second example embodiment of the present invention.

FIG. 8 is a diagram illustrating a configuration of an information communication system in accordance with a third example embodiment of the present invention.

FIG. 9 is a f flowchart illustrating a flow of an information communication method carried out by the information communication system in accordance with the third example embodiment of the present invention.

FIG. 10 is a block diagram illustrating a configuration of a computer that functions as a server apparatus or an information communication system in accordance with each example embodiment.

### EXAMPLE EMBODIMENTS

### First Example Embodiment

The following description will discuss a first example embodiment of the present invention in detail, with reference to the drawings. The present example embodiment is a basic form of example embodiments described later. Note that reference signs which are indicated in the drawings and are used in this overview are given to elements for convenience as an example for assisting in understanding, and are not intended to limit the present invention to the illustrated aspects. The connection lines between blocks in the drawings and the like referred to in the descriptions below include both a bidirectional relation and a unidirectional relation. The one-way arrow schematically indicates a flow of a main signal (data), and does not exclude bidirectionality. The connection point of an input and an output of each of the blocks in the drawings may be configured to include a port or an interface. The configurations of these are not illustrated.

<Server Apparatus 1 in Accordance with First Example Embodiment>

FIG. 1 is a diagram illustrating, with example vehicles, a configuration of a server apparatus 1 in accordance with the first example embodiment of the present invention. The server apparatus 1 in accordance with the present example embodiment includes, as illustrated in FIG. 1, a reception means 11, a selection means 12, and a transmission means 13. The server apparatus 1 can be configured by a server which is provided on a cloud infrastructure, the Internet, or the like. The server apparatus 1 can be a multi-access edge computing (MEC) server or a mobile edge computing (MEC) server which is provided at a position close to a base station.

The reception means 11 receives, from a first vehicle 31, a communication request message using wireless communication, the communication request message designating a selection condition for selecting another vehicle. For example, the reception means 11 receives a communication request message from the first vehicle 31 using C-V2X.

C-V2X of LTE (LTE V2X) and C-V2X of 5G (NR V2X) each include two types of communication modes, i.e., direct communication (PC5 communication) and indirect communication (Uu communication). The Uu communication is a mode for carrying out communication via a base station, and is carried out by an ordinary smart phone or the like. Note that the Uu communication is unicast-type communication and is sometimes referred to as vehicle-to-network (V2N) communication.

The PC5 communication is a mode in which direct communication is carried out between vehicles and between vehicles and infrastructure without using a base station therebetween. Such types of communication are sometimes referred to as V2V communication and V21 communication. The PC5 communication is generally broadcast-type communication, and is not suitable for large-volume communication due to restrictions on bandwidth and wireless protocol specifications.

One example object of the present invention is to acquire a Uu communication address of a communication partner using PC5 broadcast communication, and carry out large-volume communication by Uu communication using the acquired communication address. Hereinafter, unless otherwise specified, the simple term “C-V2X” refers to PC5 communication.

Note that, instead of the PC5 communication, it is possible to use dedicated short range communications (DSRC), which is a wireless-LAN-based vehicle-to-vehicle communication technique. The DSRC is also a broadcast-type communication. In the DSRC, for example, identification information is transmitted in a DSRC broadcast, and communication address information for Uu communication of LTE/5G is acquired from a target vehicle.

In the PC5 communication of C-V2X, communication is basically carried out by broadcast communication. Therefore, the first vehicle 31 carries out broadcast communication designating the server apparatus 1. Note that transmission of a communication request message from the vehicle 31 to the server apparatus 1 is not limited to the C-V2X broadcast communication, and may be another communication method.

Examples of data exchanged by the V2X communication technique include road traffic information, data pertaining to a behavior of an automobile, data pertaining to formation and follow-up travelling, data pertaining to automatic driving, and the like. In the present example embodiment, among these pieces of data, it is possible to utilize data pertaining to a behavior of an automobile, in particular, information on a travelling area, positional information, a travelling speed, and a travelling distance of the automobile, driving characteristics such as acceleration and deceleration and steering, a status of the automobile, and the like.

The selection condition is a condition for selecting another vehicle. For example, the selection condition is a case where a vehicle (such as a truck) which obstructs sight is present in front of the first vehicle 31 in a traveling direction, and a vehicle in front of the truck is selected, or the like.

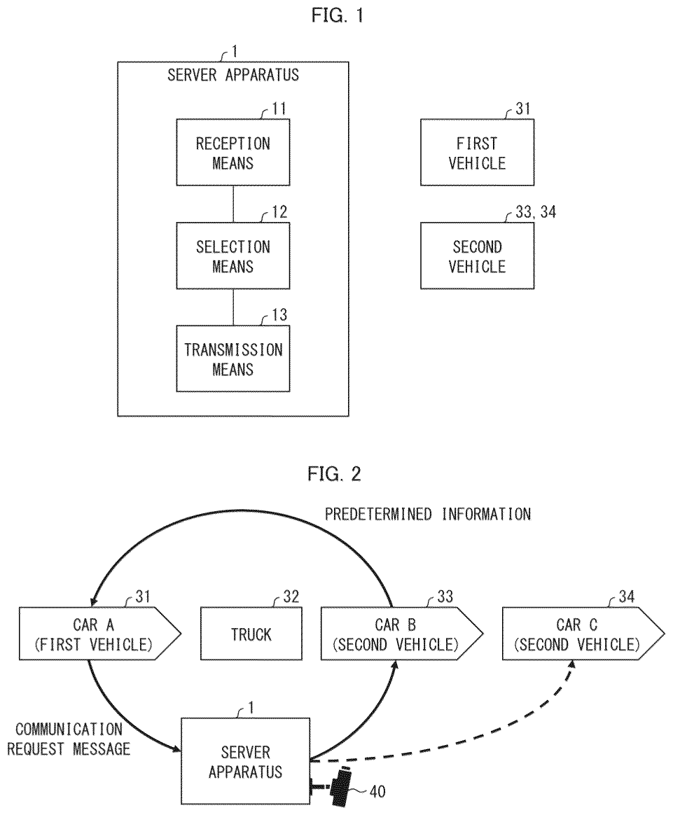

FIG. 2 is a diagram for describing an example of a selection condition for selecting another vehicle. In FIG. 2, the first vehicle corresponds to a car A 31, and the second vehicle corresponds to a car B 33 and a car C 34. A truck 32 is present in front of the car A 31, which is a first vehicle, in a traveling direction and, when seen from a driver of the car A 31, sight in front of the truck 32 is obstructed. In a case where the driver of the car A 31 wants an image in front of the truck 32, the selection condition is a vehicle having an image in front of the truck 32. The driver of the car A 31 transmits, using an in-vehicle terminal, a communication request message designating a selection condition. The communication request message includes, for example, positional information of the car A 31.

The selection means 12 selects second vehicles 33 and 34 which satisfy the selection condition. For example, in a case where the communication request message received from the car A 31 includes positional information of the car A 31, the selection means 12 can identify the truck 32 which travels in front of the car A 31 as illustrated in FIG. 2. For example, the server apparatus 1 can acquire, using V2X, positional information of a vehicle which is present in a V2X service area. The server apparatus 1 can acquire, using V2X, information pertaining to a vehicle type of a vehicle which is present in the V2X service area. Therefore, the selection means 12 can identify the truck 32 which obstructs sight of the car A 31 based on pieces of positional information and vehicle types of respective vehicles.

Note that the truck 32 which obstructs sight of the car A 31 is not limited to a vehicle which travels immediately ahead of the car A 31, and may be, for example, a truck which travels several vehicles ahead of the car A 31. In this case, the selection means 12 selects, from the positional information of the car A 31, several vehicles which travel ahead of the car A 31, and identifies a vehicle which obstructs sight of the car A 31 based on vehicle types of the respective vehicles.

Once the selection means 12 has identified the truck 32, the selection means 12 then selects, as second vehicles, a car B 33 and a car C 34 which are present in front of the truck 32 based on pieces of positional information of respective vehicles which are present in the V2X service area. Note that the selection means 12 may select the truck 32 as a second vehicle. This is because the truck 32 itself may have a video in front of the truck 32.

The transmission means 13 transmits a communication request message to the second vehicles 33 and 34. The transmission means 13, for example, designates the second vehicles 33 and 34 and transmits a communication request message using C-V2X broadcast communication. In the broadcast communication, a communication request message is to be transmitted to all vehicles in the V2X service area. However, vehicles other than the designated vehicle(s) discard the received communication request message.

In a case of responding to the communication request message, upon receipt of the communication request message, in-vehicle terminals of the car B 33 and the car C 34 which are the second vehicles each transmit communication connection information of that in-vehicle terminal mounted on the own vehicle to the car A 31 which is the first vehicle. Examples of the communication connection information include, but not limited to, an IP address and the like. The communication connection information only needs to be information with which a communication partner can be identified.

The in-vehicle terminal can carry out communication using a fifth-generation mobile communication system (5G) core network or a fourth-generation mobile communication system (4G) core network that is defined by the third-generation mobile communication system partnership project (3GPP). Note that the network is not limited to these.

Upon receipt of communication connection information from the car B 33 or the car C 34, the in-vehicle terminal of the car A 31 can carry out large-volume data communication (such as video information) with the car B 33 or the car C 34 using a communication network such as 5G or 4G. Therefore, the car A 31 can acquire a video in front of the truck 32.

<Example Advantage of Server Apparatus 1 in Accordance with First Example Embodiment>

As described above, according to the server apparatus 1 in accordance with the present example embodiment, the selection means 12 selects the second vehicles 33 and 34 which satisfy the selection condition, and the transmission means 13 transmits the communication request message to the second vehicles 33 and 34. Therefore, the first vehicle 31 can carry out communication while identifying a vehicle of an intended condition by designating, with the communication request message, a selection condition for selecting another vehicle.

### <Flow of Information Communication Method by Server Apparatus 1>

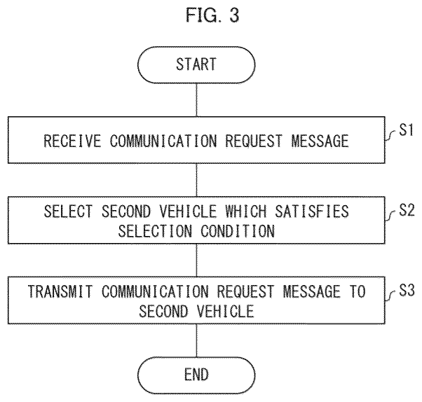

The following description will discuss a flow of an information communication method that is carried out by the server apparatus 1 configured as described above, with reference to FIG. 3. FIG. 3 is a flowchart illustrating a flow of an information communication method carried out by the server apparatus 1 in accordance with the first example embodiment of the present invention. As illustrated in FIG. 3, the information communication method includes steps S1 through S3.

First, the reception means 11 receives, from a first vehicle, a communication request message using wireless communication, the communication request message designating a selection condition for selecting another vehicle (S1). For example, the reception means 11 receives a communication request message from the first vehicle 31 using C-V2X.

Next, the selection means 12 selects a second vehicle which satisfies the selection condition (S2). For example, the selection means 12 can identify a truck 32 which obstructs sight of a car A 31 illustrated in FIG. 2 based on pieces of positional information and vehicle types of respective vehicles. The selection means 12 selects, as second vehicles, a car B 33 and a car C 34 which are present in front of the truck 32 illustrated in FIG. 2.

Lastly, the transmission means 13 transmits, to the second vehicle, the communication request message (S3). The transmission means 13, for example, designates the second vehicles 33 and 34 and transmits a communication request message using C-V2X broadcast communication.

<Example Advantage of Information Communication Method by Server Apparatus 1 in Accordance with First Example Embodiment>

As described above, according to the information communication method carried out by the server apparatus 1 in accordance with the present example embodiment, the second vehicles 33 and 34 that satisfy the selection condition are selected, and the communication request message is transmitted to the second vehicles 33 and 34. Therefore, the first vehicle 31 can carry out communication while identifying a vehicle of an intended condition by designating, with the communication request message, a selection condition for selecting another vehicle.

### <Configuration of Information Communication System 100>

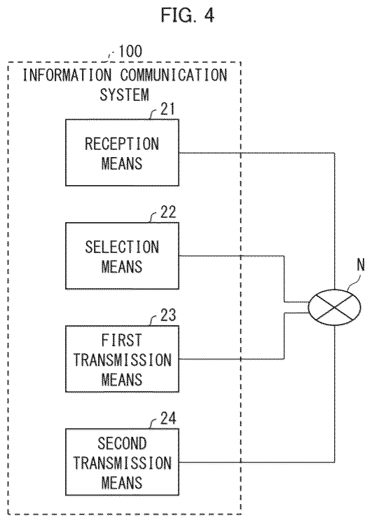

The following description will discuss a configuration of an information communication system 100 in accordance with the present example embodiment, with reference to FIG. 4. FIG. 4 is a block diagram illustrating a configuration of the information communication system 100 in accordance with the first example embodiment of the present invention. As illustrated in FIG. 4, the information communication system 100 includes a reception means 21, a selection means 22, a first transmission means 23, and a second transmission means 24.

The reception means 21, the selection means 22, the first transmission means 23, and the second transmission means 24 are configured to be communicable with each other via, for example, a network N. Here, a specific configuration of the network N does not limited the present example embodiment and, as an example, it is possible to employ the foregoing V2X, 5G core network, 4G core network, or the like.

The reception means 21 is, for example, disposed in the foregoing server apparatus 1 and receives, from the first vehicle 31 illustrated in FIG. 2, a communication request message using wireless communication, the communication request message designating a selection condition for selecting another vehicle. For example, the reception means 21 receives a communication request message from the first vehicle 31 illustrated in FIG. 2 using C-V2X.

The selection means 22 is, for example, disposed in the foregoing server apparatus 1, and selects a second vehicle which satisfies the selection condition. For example, the selection means 22 can identify a truck 32 which obstructs sight of a car A 31 illustrated in FIG. 2 based on pieces of positional information and vehicle types of respective vehicles. The selection means 22 selects, as second vehicles, a car B 33 and a car C 34 which are present in front of the truck 32 illustrated in FIG. 2.

The first transmission means 23 is, for example, disposed in the foregoing server apparatus 1, and transmits a communication request message to the second vehicles 33 and 34 illustrated in FIG. 2. The first transmission means 23, for example, designates the second vehicles 33 and 34 illustrated in FIG. 2 and transmits a communication request message using C-V2X broadcast communication.

The second transmission means 24 is, for example, disposed in each of the foregoing second vehicles 33 and 34, and transmits, to the first vehicle 31, predetermined information possessed by each of the second vehicles 33 and 34. The predetermined information possessed by each of the second vehicles 33 and 34 is communication connection information, for example, an IP address or the like. The predetermined information possessed by each of the second vehicles 33 and 34 can be an image which has been taken by an imaging apparatus that is mounted on each of the second vehicles 33 and 34.

Transmission of the predetermined information by the second transmission means 13 can be unicast communication or broadcast communication. For example, in a case where a transmission source IP address of the communication request message is included in a header portion or a data portion of the communication request message, the predetermined information may be transmitted to the IP address by unicast communication.

In a case where an identifier of the communication request message is included in a header portion or a data portion of the communication request message, the predetermined information may be transmitted by broadcast communication with information indicating that the predetermined information is a response to the identifier.

### <Flow of Information Communication Method by Information Communication System 100>

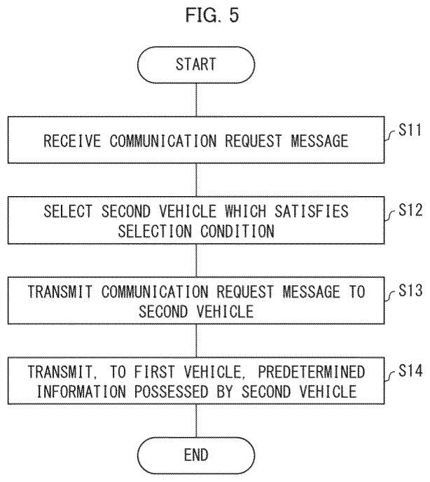

The following description will discuss a flow of an information communication method that is carried out by the information communication system 100 configured as described above, with reference to FIG. 5. FIG. 5 is a flowchart illustrating a flow of an information communication method carried out by the information communication system 100 in accordance with the first example embodiment of the present invention. As illustrated in FIG. 5, the information communication method includes steps S11 through S14.

First, the reception means 21 receives, from a first vehicle, a communication request message using wireless communication, the communication request message designating a selection condition for selecting another vehicle (S11). For example, the reception means 21 receives a communication request message from the first vehicle 31 illustrated in FIG. 2 using C-V2X.

Next, the selection means 22 selects a second vehicle which satisfies the selection condition (S12). For example, the selection means 22 can identify a truck 32 which obstructs sight of a car A 31 illustrated in FIG. 2 based on pieces of positional information and vehicle types of respective vehicles. The selection means 12 selects, as second vehicles, a car B 33 and a car C 34 which are present in front of the truck 32 illustrated in FIG. 2.

Next, the first transmission means 23 transmits, to the second vehicle, the communication request message (S13). The first transmission means 23, for example, designates the second vehicles 33 and 34 and transmits a communication request message using C-V2X broadcast communication.

Lastly, the second transmission means 24 transmits, to the first vehicle 31, predetermined information possessed by each of the second vehicles 33 and 34 (S14).

<Example Advantage of Information Communication System 100 in Accordance with First Example Embodiment>

As described above, according to the information communication system 100 in accordance with the present example embodiment, the selection means 22 selects the second vehicles 33 and 34 which satisfy the selection condition, and the first transmission means 23 transmits the communication request message to the second vehicles 33 and 34. Therefore, the first vehicle 31 can carry out communication while identifying a vehicle of an intended condition by designating, with the communication request message, a selection condition for selecting another vehicle.

### [Variation of First Example Embodiment]

The following description will discuss a variation of the first example embodiment of the present invention in detail, with reference to the drawings. The same reference numerals are given to constituent elements which have functions identical with those described in the first example embodiment, and descriptions as to such constituent elements are omitted as appropriate.

<Server Apparatus 1A in Accordance with Variation of First Example Embodiment>

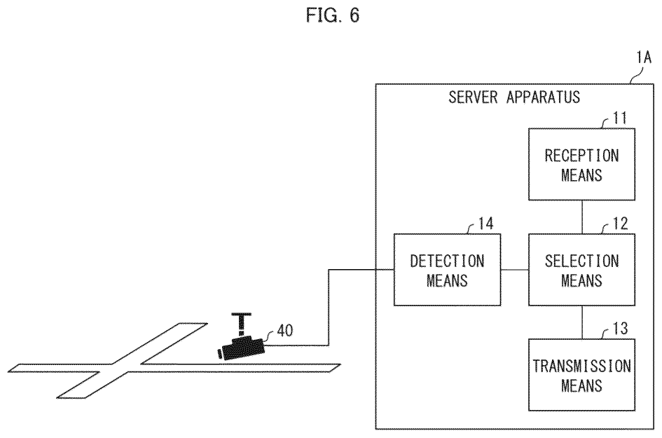

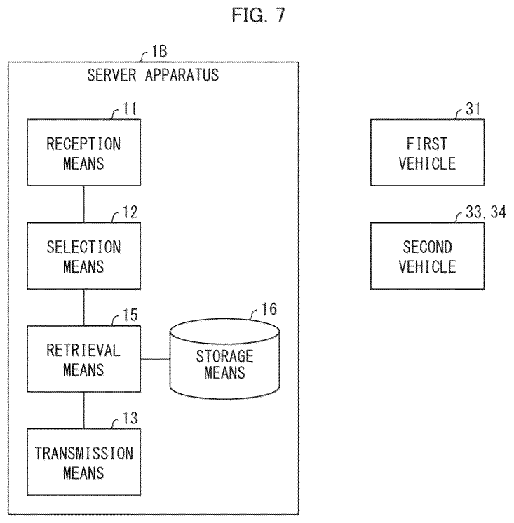

FIG. 6 is a diagram illustrating, with example intersection and imaging apparatus 40, a configuration of a server apparatus 1A in accordance with a variation of the first example embodiment of the present invention. The server apparatus 1A in accordance with this variation includes, as illustrated in FIG. 6, a reception means 11, a selection means 12, a transmission means 13, and a detection means 14.

The imaging apparatus 40 is provided in a traffic light or the like at an intersection and provides a captured video to the server apparatus 1A. Note that a location where the imaging apparatus 40 is installed can be a location other than a traffic light at an intersection, and can be architecture such as a building, a power pole, or the like near an intersection.

The reception means 11 receives, from a first vehicle 31, a communication request message using wireless communication, the communication request message designating a selection condition for selecting another vehicle. For example, the reception means 11 receives a communication request message from the first vehicle 31 using C-V2X.

The selection condition is a condition for selecting another vehicle and includes, for example, at least one item selected from the group consisting of license plate information, a vehicle type, and a body color of a vehicle. The selection condition is not limited to these, as long as the selection condition is information indicating a characteristic of a vehicle. The selection condition is a condition for directly selecting the car B 33 or the car C 34 which is a second vehicle illustrated in FIG. 2.

The selection condition may include lane information of a lane (e.g., a first travelling lane, a second travelling lane, an overtaking lane, or the like) on which the second vehicle is traveling. The lane information may be set as another selection condition, and the detection means 14 may select a second vehicle based on a combination of the selection condition and the lane information.

The detection means 14 detects a vehicle from an image which has been taken by the imaging apparatus 40. For example, the detection means 14 carries out an analysis process of inputting an image from the imaging apparatus 40 that is provided in a traffic light, and analyzing the image to detect a vehicle included in the image. The detection means 14 can detect a vehicle using, for example, a regional convolutional neural network (R-CNN).

The detection means 14 extracts a body color of a vehicle from an image of the detected vehicle. In a case where it is possible to further detect a vehicle type from an image of the detected vehicle, the detection means 14 detects a vehicle type of the vehicle by an analysis process. In a case where the detection means 14 cannot detect a vehicle type of a vehicle, the detection means 14 may acquire a vehicle type of a target vehicle using V2X information.

The detection means 14 further extracts license plate information of the vehicle from the image of the detected vehicle. The license plate information is preferably information of an entire license plate of a vehicle. However, in a case where a part of the license plate is hidden by another object, the license plate information may be information of a part of the license plate.

Note that the detection means 14 can identify positional information of the detected vehicle based on positional information indicating a positon where the imaging apparatus 40 is provided. Therefore, the selection means 12 can identify, by referring to V2X information, which vehicle in the V2X service area corresponds to the vehicle detected by the detection means 14.

The selection means 12 selects a second vehicle based on whether or not at least one item of the selection condition conforms to a characteristic of the vehicle which has been detected by the detection means 14. For example, in a case where the communication request message received from the car A 31 illustrated in FIG. 2 includes a body color which is a selection condition, the selection means 12 selects, as a second vehicle, a vehicle whose body color conforms to that selection condition among vehicles detected by the detection means 14.

In a case where the communication request message received from the car A 31 illustrated in FIG. 2 includes a vehicle type which is a selection condition, the selection means 12 selects, as a second vehicle, a vehicle whose vehicle type conforms to that selection condition among vehicles detected by the detection means 14.

In a case where the communication request message received from the car A 31 illustrated in FIG. 2 includes license plate information which is a selection condition, the selection means 12 selects, as a second vehicle, a vehicle whose license plate information partially or entirely conforms to that selection condition among vehicles detected by the detection means 14.

The communication request message may include a plurality of selection conditions among license plate information, a vehicle type, and a body color of a vehicle. In this case, the selection means 12 selects, as a second vehicle, a vehicle whose characteristics conform to the plurality of selection conditions among vehicles detected by the detection means 14.

The transmission means 13 transmits, to the second vehicle, the communication request message. For example, in a case where the car B 33 or the car C 34 has been selected as a second vehicle, the transmission means 13 designates the car B 33 or the car C 34 and transmits a communication request message using C-V2X broadcast communication.

For example, the transmission means 13 transmits a communication request message to the car B 33 or the car C 34 which is a second vehicle so as to cause the car B 33 or the car C 34 to transmit, to the first vehicle 31, sensing information (predetermined information possessed by the second vehicle) which has been acquired by a sensing apparatus mounted on the car B 33 or the car C 34 which is the second vehicle. Examples of the sensing apparatus include a visible light camera, an infrared sensor, an ultrasonic sensor, a light detection and ranging (LiDAR), a millimeter-wave radar, and the like. In a case where the sensing apparatus is an imaging apparatus such as a visible light camera, the transmission means 13 transmits a communication request message so that image information which has been obtained by the imaging apparatus is transmitted to the first vehicle 31.

The transmission means 13 may transmit a communication request message to the car B 33 or the car C 34 which is a second vehicle so as to cause the car B 33 or the car C 34 to transmit, to the first vehicle 31, communication connection information (predetermined information possessed by the second vehicle) of the car B 33 or the car C 34, which is the second vehicle, in the wireless communication.

The transmission means 13 may transmit, to the car B 33 or the car C 34 which is the second vehicle, a communication request message including communication connection information of the first vehicle 31 in the wireless communication.

<Example Advantage of Server Apparatus 1A in Accordance with Variation of First Example Embodiment>

As described above, according to the server apparatus 1A in accordance with this variation, the selection means 12 selects a second vehicle based on whether or not at least one item of the selection condition conforms to a characteristic of the vehicle which has been detected by the detection means 14. Therefore, the first vehicle 31 can carry out communication while identifying an arbitrary vehicle by designating, with the communication request message, a characteristic of another vehicle.

The transmission means 13 transmits, to the second vehicle, the communication request message so as to cause the second vehicle to transmit, to the first vehicle 31, sensing information which has been acquired by a sensing apparatus that is mounted on the second vehicle. Therefore, even in a case where there is a vehicle which obstructs sight in front of the first vehicle 31, it is possible to acquire information pertaining to the front of the vehicle which obstructs the sight.

The transmission means 13 transmits, to the second vehicle, the communication request message so as to cause the second vehicle to transmit, to the first vehicle 31, communication connection information of the second vehicle in wireless communication. Therefore, the first vehicle 31 can carry out large-volume data communication with the second vehicle.

The transmission means 13 transmits, to the second vehicle, the communication request message including communication connection information of the first vehicle 31 in the wireless communication. Therefore, the second vehicle can carry out communication with the first vehicle 31 without using broadcast communication.

### Second Example Embodiment

The following description will discuss a second example embodiment of the present invention in detail, with reference to the drawings. The same reference numerals are given to constituent elements which have functions identical with those described in the first example embodiment and the variation, and descriptions as to such constituent elements are omitted as appropriate.

<Server Apparatus 1B in Accordance with Second Example Embodiment>

FIG. 7 is a diagram illustrating, with example vehicles, a configuration of a server apparatus 1B in accordance with the second example embodiment of the present invention. The server apparatus 1B in accordance with the present example embodiment includes, as illustrated in FIG. 7, a reception means 11, a selection means 12, a transmission means 13, a retrieval means 15, and a storage means 16. The reception means 11 receives, from a first vehicle 31, a communication request message using wireless communication, the communication request message designating a selection condition for selecting another vehicle. For example, the selection condition is being a vehicle which is positioned in front of a specific vehicle which is in front of the first vehicle 31 in a traveling direction.

As illustrated in FIG. 2, when seen from a driver of a car A 31, a truck 32 which obstructs sight corresponds to the specific vehicle. A car B 33 and a car C 34 correspond to the vehicles which are positioned in front of the specific vehicle.

The selection means 12 identifies the specific vehicle (truck 32) with reference to positional information of the first vehicle 31, and selects, as a second vehicle, a vehicle which is positioned in front of the specific vehicle (truck 32). As described above, the server apparatus 1 can acquire, using V2X, positional information of a vehicle which is present in a V2X service area. For example, the selection means 12 can identify a traveling direction of the first vehicle 31 based on a change in positional information of the first vehicle 31, and can identify, as the specific vehicle 32, a vehicle which has positional information of being in front of the first vehicle 31 in the traveling direction. The selection means 12 can select, as a second vehicle, a vehicle which has positional information of being in front of the specific vehicle 32.

The selection means 12 may identify the first vehicle 31 with reference to positional information of the specific vehicle (truck 32), and select, as second vehicles 33 and 34, vehicles which are positioned in front of the specific vehicle (truck 32). For example, the selection means 12 identifies, as a first vehicle 31, a vehicle which is immediately behind the specific vehicle (truck 32). For example, the selection means 12 can identify a traveling direction of the specific vehicle 32 based on a change in positional information of the specific vehicle 32, and can identify, as the first vehicle 31, a vehicle which has positional information of being behind the specific vehicle 32 in the traveling direction. The detection means 14 described in the variation of the first example embodiment may identify the first vehicle 31 from an image which has been taken by the imaging apparatus 40.

The storage means 16 stores pieces of positional information of respective vehicles included in a vehicle group and pieces of communication connection information of the respective vehicles in the wireless communication in association with each other.

The retrieval means 15 retrieves pieces of positional information corresponding to pieces of positional information of the second vehicles 33 and 34 with reference to the pieces of positional information of the respective vehicles which are stored in the storage means 16.

In a case where the storage means 16 stores pieces of positional information corresponding to the pieces of positional information of the second vehicles 33 and 34, the transmission means 13 transmits, to the first vehicle 31, pieces of communication connection information corresponding to the second vehicles 33 and 34 which are stored in the storage means 16.

In a case where pieces of positional information corresponding to the pieces of positional information of the second vehicles 33 and 34 are not stored in the storage means 16, the transmission means 13 transmits a communication request message using broadcast wireless communication. In this case, the reception means 11 receives pieces of communication connection information of the second vehicles 33 and 34 which are transmitted from the second vehicles 33 and 34 to the first vehicle 31. The retrieval means 15 causes the storage means 16 to store the pieces of positional information of the second vehicles 33 and 34 and the pieces of communication connection information of the vehicles 33 and 34 which have been received by the reception means 11 in association with each other.

Thus, in a case where positional information corresponding to positional information of the second vehicle is not stored in the storage means 16, the retrieval means 15 causes the storage means 16 to store the positional information of the second vehicle and the received communication connection information of the second vehicle in association with each other. In a case where the selection means 12 has again selected a second vehicle having the same positional information, the retrieval means 15 outputs, to the transmission means 13, communication connection information corresponding to the second vehicle which is stored in the storage means 16. The transmission means 13 transmits, to the first vehicle 31, communication connection information of the second vehicle. Therefore, the transmission means 13 does not need to transmit a communication request message to the second vehicle, and this makes it possible to shorten a processing time.

<Example Advantage of Server Apparatus 1B in Accordance with Second Example Embodiment>

As described above, according to the server apparatus 1B in accordance with the present example embodiment, the selection means 12 identifies the specific vehicle (truck 32) with reference to positional information of the first vehicle 31, and selects, as a second vehicle, a vehicle which is positioned in front of the specific vehicle (truck 32). Therefore, the selection means 12 can easily select a second vehicle which conforms to the selection condition.

The selection means 12 identifies the first vehicle 31 with reference to positional information of the specific vehicle (truck 32), and selects, as a second vehicle, a vehicle which is positioned in front of the specific vehicle (truck 32). Therefore, even in a case where information with which the first vehicle 31 can be identified is not included in the communication request message, the selection means 12 can easily identify the first vehicle 31.

In a case where the storage means 16 stores positional information corresponding to positional information of the second vehicle, the transmission means 13 transmits, to the first vehicle 31, communication connection information corresponding to the second vehicle which is stored in the storage means 16. Therefore, the transmission means 13 does not need to transmit a communication request message to the second vehicle, and this makes it possible to shorten a processing time.

### Third Example Embodiment

The following description will discuss a third example embodiment of the present invention in detail, with reference to the drawings. The same reference numerals are given to constituent elements which have functions identical with those described in the first example embodiment, and descriptions as to such constituent elements are omitted as appropriate.

<Information Communication System 100A in Accordance with Third Example Embodiment>

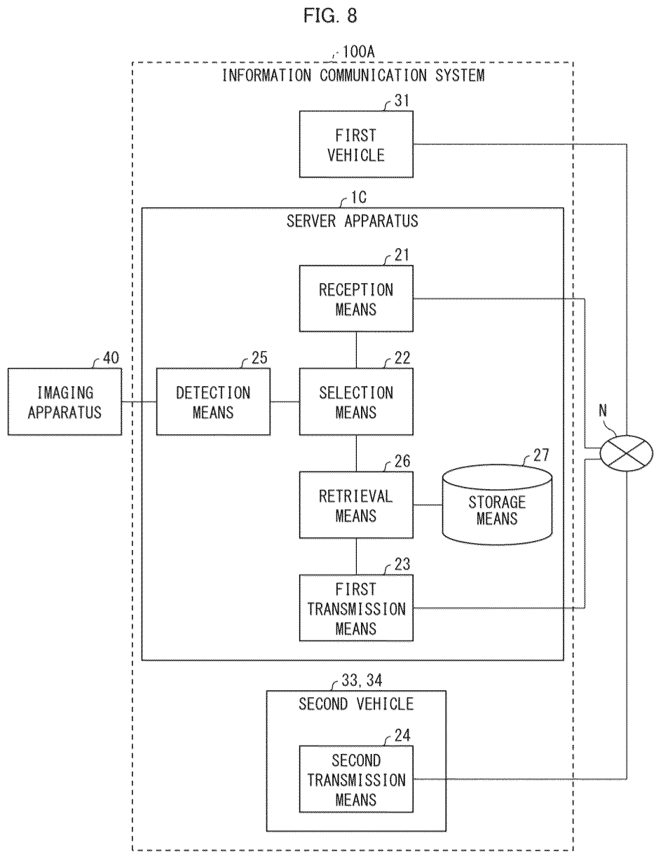

FIG. 8 is a diagram illustrating a configuration of an information communication system 100A in accordance with the third example embodiment of the present invention. The information communication system 100A in accordance with the present example embodiment includes, as illustrated in FIG. 8, a server apparatus 1C, a first vehicle 31, and second vehicles 33 and 34.

The server apparatus 1C includes a reception means 21, a selection means 22, a first transmission means 23, a detection means 25, a retrieval means 26, and a storage means 27. The first vehicle 31, the reception means 21, the first transmission means 23, and the second transmission means 24 of each of the second vehicles 33 and 34 are configured to be communicable with each other via, for example, a network N. Here, a specific configuration of the network N does not limited the present example embodiment and, as an example, it is possible to employ the foregoing V2X, 5G core network, 4G core network, or the like.

The reception means 21 receives, from the first vehicle 31, a communication request message using wireless communication, the communication request message designating a selection condition for selecting another vehicle. For example, the reception means 21 receives a communication request message from the first vehicle 31 using C-V2X.

The detection means 25 detects a vehicle from an image which has been taken by an imaging apparatus 40. For example, the detection means 25 carries out an analysis process of inputting an image from the imaging apparatus 40 that is provided in a traffic light, and analyzing the image to detect a vehicle included in the image.

The selection means 22 selects a second vehicle which satisfies the selection condition. For example, the selection means 22 can identify a truck 32 which obstructs sight of a car A 31 illustrated in FIG. 2 based on pieces of positional information and vehicle types of respective vehicles. The selection means 22 selects, as the second vehicles, a car B 33 and a car C 34 which are present in front of the truck 32 illustrated in FIG. 2.

The selection means 22 may select a second vehicle based on whether or not at least one item of the selection condition conforms to a characteristic of the vehicle which has been detected by the detection means 25. For example, in a case where the communication request message received from the car A 31 illustrated in FIG. 2 includes a body color which is a selection condition, the selection means 22 selects, as a second vehicle, a vehicle whose body color conforms to that selection condition among vehicles detected by the detection means 25.

The storage means 27 stores pieces of positional information of respective vehicles included in a vehicle group and pieces of communication connection information of the respective vehicles in the wireless communication in association with each other.

The retrieval means 26 retrieves pieces of positional information corresponding to pieces of positional information of the second vehicles 33 and 34 with reference to the pieces of positional information of the respective vehicles which are stored in the storage means 27.

Retrieval of positional information is not limited to a case of complete conformity. For example, in a case where a difference between (i) the pieces of positional information of the second vehicles 33 and 34 and (ii) pieces of positional information of the respective vehicles which are stored in the storage means 27 is equal to or less than a predetermined value, such pieces of positional information may be regarded to conform to each other. The predetermined value may be decided based on speeds of the second vehicles 33 and 34. Specifically, as the speeds of the second vehicles 33 and 34 increase, the predetermined value may be set greater. Furthermore, a moving direction may be further taken into consideration. This is to determine whether a direction of the error conforms to the vehicle traveling direction.

In a case where the storage means 27 stores pieces of positional information corresponding to the pieces of positional information of the second vehicles 33 and 34, the first transmission means 23 transmits, to the first vehicle 31, pieces of communication connection information corresponding to the second vehicles 33 and 34 which are stored in the storage means 27.

In a case where pieces of positional information corresponding to the pieces of positional information of the second vehicles 33 and 34 are not stored in the storage means 27, the first transmission means 23 transmits the communication request message using broadcast wireless communication.

### <Flow of Information Communication Method by Information Communication System 100A>

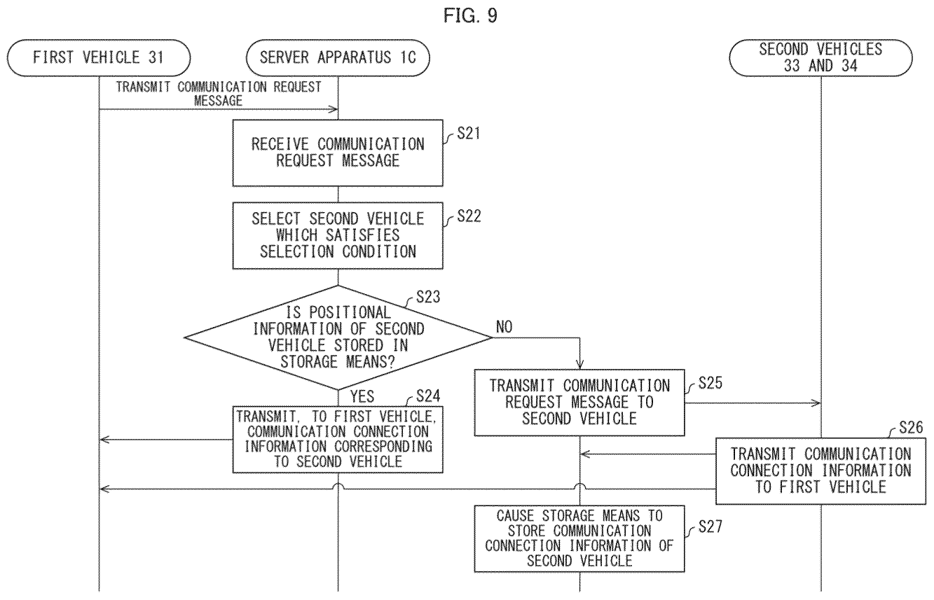

The following description will discuss a flow of an information communication method that is carried out by the information communication system 100A configured as described above, with reference to FIG. 9. FIG. 9 is a flowchart illustrating a flow of an information communication method carried out by the information communication system 100A in accordance with the third example embodiment of the present invention. As illustrated in FIG. 9, the information communication method includes steps S21 through S27.

First, the first vehicle 31 transmits a communication request message to the server apparatus 1C using wireless communication. The reception means 21 receives, from the first vehicle 31, the communication request message using the wireless communication, the communication request message designating a selection condition for selecting another vehicle (S21). For example, the reception means 21 receives a communication request message from the first vehicle 31 illustrated in FIG. 2 using C-V2X.

Next, the selection means 22 selects a second vehicle which satisfies the selection condition (S22). For example, the selection means 22 can identify a truck 32 which obstructs sight of a car A 31 illustrated in FIG. 2 based on pieces of positional information and vehicle types of respective vehicles. The selection means 12 selects, as second vehicles, a car B 33 and a car C 34 which are present in front of the truck 32 illustrated in FIG. 2.

Next, the retrieval means 26 determines whether or not the pieces of positional information of the second vehicles 33 and 34 are stored in the storage means 27 with reference to the pieces of positional information of the respective vehicles which are stored in the storage means 27 (S23).

In a case where the pieces of positional information of the second vehicles 33 and 34 are stored in the storage means 27 (S23, Yes), the first transmission means 23 transmits, to the first vehicle 31, pieces of communication connection information corresponding to the second vehicles 33 and 34 which are stored in the storage means 27 (S24).

In a case where the pieces of positional information of the second vehicles 33 and 34 are not stored in the storage means 27 (S23, No), the first transmission means 23 transmits a communication request message to the second vehicles 33 and 34 (S25).

In a case where the second vehicles 33 and 34 have received the communication request message from the server apparatus 1C, the second transmission means 24 of the in-vehicle terminal of each of the second vehicles 33 and 34 transmits its own communication connection information to the first vehicle 31. At this time, the second transmission means 24 transmits its own communication connection information also to the server apparatus 1C (S26).

In a case where the reception means 21 of the server apparatus 1C has received the pieces of communication connection information from the second vehicles 33 and 34, the retrieval means 26 causes the storage means 27 to store the pieces of positional information of the second vehicles and the received pieces of communication connection information of the second vehicles in association with each other (S27).

<Example Advantage of Information Communication System 100A in Accordance with Third Example Embodiment>

As described above, according to the information communication system 100A in accordance with the present example embodiment, in a case where the storage means 27 stores positional information corresponding to positional information of the second vehicle, the first transmission means 23 transmits, to the first vehicle 31, communication connection information corresponding to the second vehicle which is stored in the storage means 27. Therefore, the first transmission means 23 does not need to transmit a communication request message to the second vehicle, and this makes it possible to shorten a processing time.

### [Software Implementation Example]

The functions of part of or all of the server apparatuses 1 and 1A through 1C and the information communication systems 100 and 100A can be realized by hardware such as an integrated circuit (IC chip) or can be alternatively realized by software.

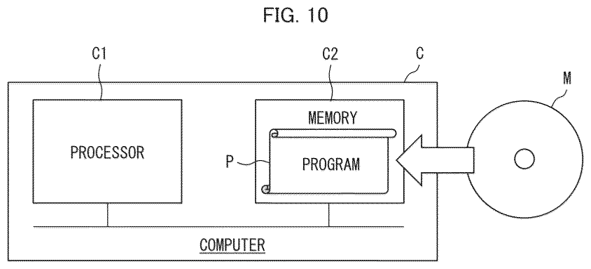

In the latter case, each of the server apparatuses 1 and 1A through 1C and the information communication systems 100 and 100A is realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The memory C2 stores a program P for causing the computer C to function as each of the server apparatuses 1 and 1A through 1C and the information communication systems 100 and 100A. In the computer C, the processor C1 reads the program P from the memory C2 and executes the program P, so that the functions of the server apparatuses 1 and 1A through 1C and the information communication systems 100 and 100A are realized.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a RAM in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

A server apparatus, including: a reception means for receiving, from a first vehicle, a communication request message using wireless communication, the communication request message designating a selection condition for selecting another vehicle; a selection means for selecting a second vehicle that satisfies the selection condition; and a transmission means for transmitting the communication request message to the second vehicle.

According to the above configuration, the first vehicle can carry out communication while identifying a vehicle of an intended condition by designating, with the communication request message, a selection condition for selecting another vehicle.

### (Supplementary Note 2)

The server apparatus according to supplementary note 1, in which: the selection condition is being a vehicle which is positioned in front of a specific vehicle which is in front of the first vehicle in a traveling direction; the selection means identifies the specific vehicle with reference to positional information of the first vehicle; and the selection means selects, as the second vehicle, a vehicle which is positioned in front of the specific vehicle.

According to the above configuration, the selection means can easily select a second vehicle which conforms to the selection condition.

(Supplementary note 3)

The server apparatus according to supplementary note 1, in which: the selection condition is being a vehicle which is positioned in front of a specific vehicle which is in front of the first vehicle in a traveling direction; the selection means identifies the first vehicle with reference to positional information of the specific vehicle; and the selection means selects, as the second vehicle, a vehicle which is positioned in front of the specific vehicle.

According to the above configuration, the selection means can easily identify a first vehicle.

### (Supplementary Note 4)

The server apparatus according to supplementary note 1, in which: the selection condition includes at least one item selected from the group consisting of license plate information, a vehicle type, and a body color of a vehicle; the server apparatus further includes a detection means for detecting a vehicle from an image which has been taken by an imaging apparatus; and the selection means selects the second vehicle based on whether or not at least one item of the selection condition conforms to a characteristic of the vehicle which has been detected by the detection means.

According to the above configuration, the first vehicle can carry out communication while identifying an arbitrary vehicle by designating, with the communication request message, a characteristic of another vehicle.

### (Supplementary Note 5)

The server apparatus according to any one of supplementary notes 1 through 4, in which: the transmission means transmits, to the second vehicle, the communication request message so as to cause the second vehicle to transmit, to the first vehicle, sensing information which has been acquired by a sensing apparatus that is mounted on the second vehicle.

According to the above configuration, even in a case where there is a vehicle which obstructs sight in front of the first vehicle, it is possible to acquire information pertaining to the front of the vehicle which obstructs the sight.

### (Supplementary Note 6)

The server apparatus according to any one of supplementary notes 1 through 4, in which: the transmission means transmits, to the second vehicle, the communication request message so as to cause the second vehicle to transmit, to the first vehicle, communication connection information of the second vehicle in the wireless communication.

According to the above configuration, the first vehicle can carry out large-volume data communication with the second vehicle.

### (Supplementary Note 7)

The server apparatus according to supplementary note 5 or 6, in which: the transmission means transmits, to the second vehicle, the communication request message including communication connection information of the first vehicle in the wireless communication.

According to the above configuration, the second vehicle can carry out communication with the first vehicle without using broadcast communication.

### (Supplementary Note 8)

A server apparatus, including: a reception means for receiving, from a first vehicle, a communication request message using wireless communication, the communication request message designating a selection condition for selecting another vehicle; a selection means for selecting a second vehicle that satisfies the selection condition; a storage means for storing pieces of positional information of respective vehicles included in a vehicle group and pieces of communication connection information of the respective vehicles in the wireless communication in association with each other; a retrieval means for retrieving a piece of positional information corresponding to a piece of positional information of the second vehicle with reference to the pieces of positional information of the respective vehicles which are stored in the storage means; and a transmission means for transmitting, to the first vehicle, a piece of communication connection information which is stored in the storage means and corresponds to the second vehicle in a case where the piece of positional information corresponding to the piece of positional information of the second vehicle is stored in the storage means.

According to the above configuration, the transmission means does not need to transmit a communication request message to the second vehicle, and this makes it possible to shorten a processing time.

### (Supplementary Note 9)

The server apparatus according to supplementary note 8, in which: in a case where the piece of positional information corresponding to the piece of positional information of the second vehicle is not stored in the storage means, the transmission means transmits the communication request message using broadcast wireless communication.

### (Supplementary Note 10)

An information communication system, including: a reception means for receiving, from a first vehicle, a communication request message using wireless communication, the communication request message designating a selection condition for selecting another vehicle; a selection means for selecting a second vehicle that satisfies the selection condition; a first transmission means for transmitting the communication request message to the second vehicle; and a second transmission means for transmitting predetermined information possessed by the second vehicle to the first vehicle.

According to the above configuration, the first vehicle can carry out communication while identifying a vehicle of an intended condition by designating, with the communication request message, a selection condition for selecting another vehicle.

### (Supplementary Note 11)

The information communication system according to supplementary note 10, in which: the selection condition is being a vehicle which is positioned in front of a specific vehicle which is in front of the first vehicle in a traveling direction; the selection means identifies the specific vehicle with reference to positional information of the first vehicle; and the selection means selects, as the second vehicle, a vehicle which is positioned in front of the specific vehicle.

According to the above configuration, the selection means can easily select a second vehicle which conforms to the selection condition.

### (Supplementary Note 12)

The information communication system according to supplementary note 10, in which: the selection condition is being a vehicle which is positioned in front of a specific vehicle which is in front of the first vehicle in a traveling direction; the selection means identifies the first vehicle with reference to positional information of the specific vehicle; and the selection means selects, as the second vehicle, a vehicle which is positioned in front of the specific vehicle.

According to the above configuration, the selection means can easily identify a first vehicle.

### (Supplementary Note 13)

The information communication system according to supplementary note 10, in which: the selection condition includes at least one item selected from the group consisting of license plate information, a vehicle type, and a body color of a vehicle; the information communication system further includes a detection means for detecting a vehicle from an image which has been taken by an imaging apparatus; and the selection means selects the second vehicle based on whether or not at least one item of the selection condition conforms to a characteristic of the vehicle which has been detected by the detection means.

According to the above configuration, the first vehicle can carry out communication while identifying an arbitrary vehicle by designating, with the communication request message, a characteristic of another vehicle.

### (Supplementary Note 14)

The information communication system according to any one of supplementary notes 10 through 13, in which: the predetermined information possessed by the second vehicle is sensing information which has been acquired by a sensing apparatus that is mounted on the second vehicle.

According to the above configuration, even in a case where there is a vehicle which obstructs sight in front of the first vehicle, it is possible to acquire information pertaining to the front of the vehicle which obstructs the sight.

### (Supplementary Note 15)

The information communication system according to any one of supplementary notes 10 through 13, in which: the predetermined information possessed by the second vehicle is communication connection information of the second vehicle in the wireless communication.

According to the above configuration, the first vehicle can carry out large-volume data communication with the second vehicle.

### (Supplementary Note 16)

The information communication system according to any one of supplementary notes 10 through 15, further including: a storage means for storing pieces of positional information of respective vehicles included in a vehicle group and pieces of communication connection information of the respective vehicles in the wireless communication in association with each other; and a retrieval means for retrieving a piece of positional information corresponding to a piece of positional information of the second vehicle with reference to the pieces of positional information of the respective vehicles which are stored in the storage means, the first transmission means transmitting, to the first vehicle, a piece of communication connection information which is stored in the storage means and corresponds to the second vehicle in a case where the piece of positional information corresponding to the piece of positional information of the second vehicle is stored in the storage means.

According to the above configuration, the first transmission means does not need to transmit a communication request message to the second vehicle, and this makes it possible to shorten a processing time.

### (Supplementary Note 17)

The information communication system according to supplementary note 16, in which: in a case where the piece of positional information corresponding to the piece of positional information of the second vehicle is not stored in the storage means, the first transmission means transmits the communication request message using broadcast wireless communication.

### (Supplementary Note 18)

An information communication method, including: receiving, from a first vehicle, a communication request message using wireless communication, the communication request message designating a selection condition for selecting another vehicle; selecting a second vehicle that satisfies the selection condition; and transmitting the communication request message to the second vehicle.

According to the above configuration, the first vehicle can carry out communication while identifying a vehicle of intended condition by designating, with the an communication request message, a selection condition for selecting another vehicle.

### (Supplementary Note 19)

A program for causing a computer to carry out: a process of receiving, from a first vehicle, a communication request message using wireless communication, the communication request message designating a selection condition for selecting another vehicle; a process of selecting a second vehicle that satisfies the selection condition; and a process of transmitting the communication request message to the second vehicle.

According to the above configuration, the first vehicle can carry out communication while identifying a vehicle of an intended condition by designating, with the communication request message, a selection condition for selecting another vehicle.

### (Supplementary Note 20)

A server apparatus including at least one processor, the at least one processor carrying out: a process of receiving, from a first vehicle, a communication request message using wireless communication, the communication request message designating a selection condition for selecting another vehicle; a process of selecting a second vehicle that satisfies the selection condition; and a process of transmitting the communication request message to the second vehicle.

Note that the server apparatus can further include a memory. The memory can store a program for causing the at least one processor to carry out the reception process, the selection process, and the transmission process. The program can be stored in a computer-readable non-transitory tangible storage medium.

### (Supplementary Note 21)

An information communication system including at least one processor, the at least one processor carrying out: a process of receiving, from a first vehicle, a communication request message wireless communication, the communication request message designating a selection condition for selecting another vehicle; a process of selecting a second vehicle that satisfies the selection condition; a first transmission process of transmitting the communication request message to the second vehicle; and a second transmission process of transmitting predetermined information possessed by the second vehicle to the first vehicle.

Note that the information communication system can further include a memory. The memory can store a program for causing the at least one processor to carry out the reception process, the selection process, the first transmission process, and the second transmission process. The program can be stored in a computer-readable non-transitory tangible storage medium.

### REFERENCE SIGNS LIST

1, 1A, 1B, 1C: Server apparatus
11, 21: Reception means
12, 22: Selection means
13: Transmission means
14, 25: Detection means
15, 26: Retrieval means
16, 27: Storage means
23: First transmission means
24: Second transmission means
31: First vehicle
32: Specific vehicle
33, 34: Second vehicle
40: Imaging apparatus
100, 100A: Information communication system

What is claimed is:

1. A server apparatus, comprising at least one processor, the at least one processor carrying out:
a process of receiving, from a first vehicle, a communication request message using wireless communication, the communication request message designating a selection condition for selecting another vehicle;
a process of selecting a second vehicle that satisfies the selection condition; and
a process of transmitting the communication request message to the second vehicle.

2. The server apparatus according to claim 1, wherein:
the selection condition is being a vehicle which is positioned in front of a specific vehicle which is in front of the first vehicle in a traveling direction;
in the process of selecting, the at least one processor identifies the specific vehicle with reference to positional information of the first vehicle; and
in the process of selecting, the at least one processor selects, as the second vehicle, a vehicle which is positioned in front of the specific vehicle.

3. The server apparatus according to claim 1, wherein:
the selection condition is being a vehicle which is positioned in front of a specific vehicle which is in front of the first vehicle in a traveling direction;
in the process of selecting, the at least one processor identifies the first vehicle with reference to positional information of the specific vehicle; and
in the process of selecting, the at least one processor selects, as the second vehicle, a vehicle which is positioned in front of the specific vehicle.

4. The server apparatus according to claim 1, wherein:
the selection condition includes at least one item selected from the group consisting of license plate information, a vehicle type, and a body color of a vehicle;
the at least one processor further carries out a process of detecting a vehicle from an image which has been taken by an imaging apparatus; and
in the process of selecting, the at least one processor selects the second vehicle based on whether or not at least one item of the selection condition conforms to a characteristic of the vehicle which has been detected.

5. The server apparatus according to claim 1, wherein:
in the process of transmitting, the at least one processor transmits, to the second vehicle, the communication request message so as to cause the second vehicle to transmit, to the first vehicle, sensing information which has been acquired by a sensing apparatus that is mounted on the second vehicle.

6. The server apparatus according to claim 1, wherein:
in the process of transmitting, the at least one processor transmits, to the second vehicle, the communication request message so as to cause the second vehicle to transmit, to the first vehicle, communication connection information of the second vehicle in the wireless communication.

7. The server apparatus according to claim 5, wherein:
in the process of transmitting, the at least one processor transmits, to the second vehicle, the communication request message including communication connection information of the first vehicle in the wireless communication.

8. A server apparatus, comprising at least one processor, the at least one processor carrying out:
a process of receiving, from a first vehicle, a communication request message using wireless communication, the communication request message designating a selection condition for selecting another vehicle;
a process of selecting a second vehicle that satisfies the selection condition;
a process of storing pieces of positional information of respective vehicles included in a vehicle group and pieces of communication connection information of the respective vehicles in the wireless communication in association with each other;
a process of retrieving a piece of positional information corresponding to a piece of positional information of the second vehicle with reference to the pieces of positional information of the respective vehicles which are stored; and
a process of transmitting, to the first vehicle, a piece of communication connection information which is stored and corresponds to the second vehicle in a case where the piece of positional information corresponding to the piece of positional information of the second vehicle is stored.

9. The server apparatus according to claim 8, wherein:
in a case where the piece of positional information corresponding to the piece of positional information of the second vehicle is not stored, in the process of transmitting, the at least one processor transmits the communication request message using broadcast wireless communication.

10. An information communication system, comprising at least one processor, the at least one processor carrying out:
a process of receiving, from a first vehicle, a communication request message using wireless communication, the communication request message designating a selection condition for selecting another vehicle;
a process of selecting a second vehicle that satisfies the selection condition;
a process of transmitting the communication request message to the second vehicle; and
a process of transmitting predetermined information possessed by the second vehicle to the first vehicle.

11. The information communication system according to claim 10, wherein:
the selection condition is being a vehicle which is positioned in front of a specific vehicle which is in front of the first vehicle in a traveling direction;
in the process of selecting, the at least one processor identifies the specific vehicle with reference to positional information of the first vehicle; and
in the process of selecting, the at least one processor selects, as the second vehicle, a vehicle which is positioned in front of the specific vehicle.

12. The information communication system according to claim 10, wherein:
the selection condition is being a vehicle which is positioned in front of a specific vehicle which is in front of the first vehicle in a traveling direction;
in the process of selecting, the at least one processor identifies the first vehicle with reference to positional information of the specific vehicle; and
in the process of selecting, the at least one processor selects, as the second vehicle, a vehicle which is positioned in front of the specific vehicle.

13. The information communication system according to claim 10, wherein:
the selection condition includes at least one item selected from the group consisting of license plate information, a vehicle type, and a body color of a vehicle;
the at least one processor further carries out a process of detecting a vehicle from an image which has been taken by an imaging apparatus; and
in the process of selecting, the at least one processor selects the second vehicle based on whether or not at least one item of the selection condition conforms to a characteristic of the vehicle which has been detected.

14. The information communication system according to claim 10, wherein:
the predetermined information possessed by the second vehicle is sensing information which has been acquired by a sensing apparatus that is mounted on the second vehicle.

15. The information communication system according to claim 10, wherein:
the predetermined information possessed by the second vehicle is communication connection information of the second vehicle in the wireless communication.

16. The information communication system according to claim 10 wherein:
the at least one processor further carries out a process of storing pieces of positional information of respective vehicles included in a vehicle group and pieces of communication connection information of the respective vehicles in the wireless communication in association with each other;
the at least one processor further carries out a process of retrieving a piece of positional information corresponding to a piece of positional information of the second vehicle with reference to the pieces of positional information of the respective vehicles which are stored; and
in the process of transmitting the communication request message, the at least one processor transmits, to the first vehicle, a piece of communication connection information which is stored and corresponds to the second vehicle in a case where the piece of positional information corresponding to the piece of positional information of the second vehicle is stored.

17. The information communication system according to claim 16, wherein:
in a case where the piece of positional information corresponding to the piece of positional information of the second vehicle is not stored, in the process of transmitting the communication request message, the at least one processor transmits the communication request message using broadcast wireless communication.

18. (canceled)

19. (canceled)

20. A non-transitory storage medium storing a program for causing a computer to carry out processes of a server apparatus recited in claim 1.
